(19) United States
(12) Patent Application Publication
(10) Pub. No.: US 2010/0329503 A1
(43) Pub. Date: Dec. 30, 2010

(54) VOICE COIL AND TRANSDUCER HAVING THE VOICE COIL

(75) Inventor: YI SHAO, Shenzhen (CN)

Correspondence Address: Jamie Zheng, 3524 Waverley Street, Palo Alto, CA, 94306, US

(73) Assignees: AAC ACOUSTIC TECHNOLOGIES (SHENZHEN) CO., LTD, Shenzhen (CN); AMERICAN AUDIO COMPONENTS INC., La Verne, CA (US)

(21) Appl. No.: 12/697,284

(22) Filed: Jan. 31, 2010

(30) Foreign Application Priority Data
Jun. 26, 2009 (CN) 200910108404.1

(51) Int. Cl. H04R 1/00

(52) U.S. Cl. 381/409

(57) ABSTRACT

A voice coil is disclosed. The voice coil includes a housing and a wire wrapped around the housing. The housing defines a connecting member and a combining member connected to the connecting member. The wire wraps around the combing member. The connecting member defines an outer surface, an inner surface opposed to the outer surface, and a top surface connecting the outer and inner surfaces. The housing further includes a through hole extending from the outer surface to the inner surface.

### BACKGROUND OF THE INVENTION

1. Field of the Invention

The present invention generally relates to the art of electro-acoustic transducers and, more particularly, to a voice coil used in a micro speaker.

2. Description of Related Art

An electronic device, such as a cellular phone, a camcorder, a PDA, a digital camera, or a notebook computer, provides a space for accommodating a micro speaker therein. Nowadays, a speaker with high quality audio performance and miniature size is desired.

A related speaker comprises a case, a magnet positioned in the case, a pole plate disposed on the magnet, a diaphragm supported by the case, a voice coil attached to the diaphragm, and a cover pressing on a peripheral portion of the diaphragm. The case and the cover define a cavity. For electrically connecting the speaker to an external PCB, a plurality of terminals is provided and is connected to leads of the voice coil. When alternating currents go through the voice coil, the magnet will drive the voice coil to vibrate and the diaphragm will also vibrate with the voice coil accordingly, which converts the currents into sound waves.

However, the performance of such speaker is not so good because it is not easy to balance the air pressure in the cavity during the vibration of the diaphragm. So a new voice coil is required to overcome the disadvantage mentioned above.

### SUMMARY OF THE INVENTION

According to the present invention, a voice coil comprises a housing and a wire wrapped around the housing. The housing defines a connecting member and a combining member connected to the connecting member. The wire wraps around the combining member. The connecting member defines an outer surface, an inner surface opposed to the outer surface, and a top surface connecting the outer and inner surfaces. The housing further includes a through hole extending from the outer surface to the inner surface.

Other features of the present invention will become more apparent to those skilled in the art upon examination of the following drawings and detailed description of exemplary embodiments.

### BRIEF DESCRIPTION OF THE DRAWINGS

FIG. 1 is a schematic isometric view of a voice coil in accordance with a first embodiment of the present invention;

FIG. 2 is an enlarged view of Section A in FIG. 1;

FIG. 3 is a schematic isometric view of a voice coil in accordance with a second embodiment of the present invention; and

FIG. 4 is an enlarged view of Section A′ in FIG. 3.

### DETAILED DESCRIPTION OF THE PREFERRED EMBODIMENT

Reference will now be made to describe the exemplary embodiments of the present invention in detail.

Embodiments of the present invention provide voice coils used in micro speakers. The micro speaker comprises a case, a magnetic circuit providing a magnetic gap, a vibrating device and a cover coupled to the case. The magnetic circuit comprises a magnetic bowl coupled to the case, a magnet positioned in the magnetic bowl and a pole plate covering the magnet. The vibrating device comprises a diaphragm supported by the case and a voice coil connected to the diaphragm. The cover is pressing on peripheral portion of the diaphragm. The cover and the case define a cavity for locating the elements mentioned above. The voice coil is partially received in a magnetic gap of the magnetic circuit.

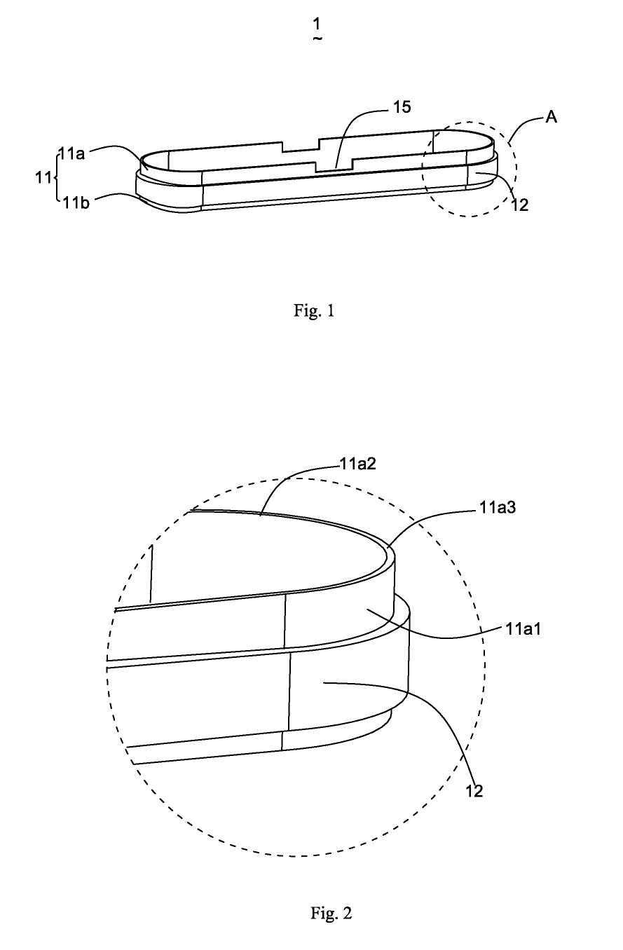

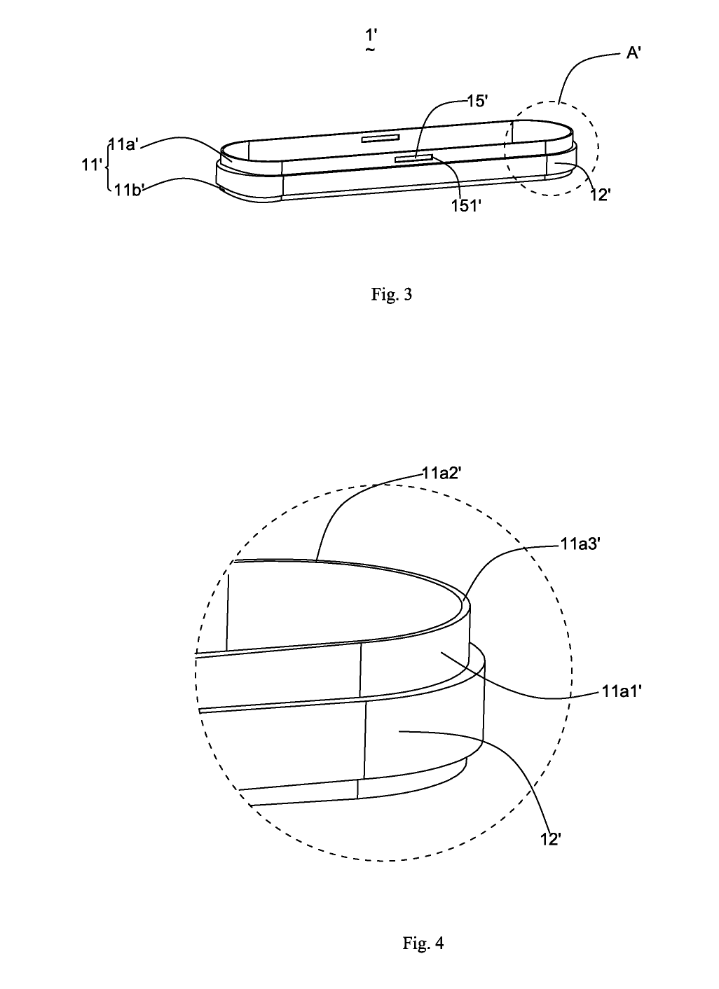

Referring to FIG. 1, in accordance with a first embodiment, a voice coil 1 comprises a housing 11 and a wire 12 wrapping around the housing 11. The housing 11 defines a connecting member 11a and a combining member 11b connected to the connecting member 11a. The wire 12 is wrapped around the combining member 11b. The connecting member 11a defines an outer surface 11a1, an inner surface 11a2, and a top surface 11a3 connecting the outer and inner surfaces. The housing 11 defines a gap 15 extending from the top surface 11a3 toward the combining member 11b, the gap 15 being a through hole extending from the outer surface 11a1 to the inner surface 11a2.

Referring to FIG. 2, in accordance with a second embodiment, a voice coil 1′ comprises a housing 11′ and a wire 12′ wrapping around the housing 11′. The housing 11′ defines a connecting member 11a′ and a combining member 11b′ connected to the connecting member 11a′. The wire 12′ is wrapped around the combining member 11b′. The connecting member 11a′ defines an outer surface 11a1′, an inner surface 11a2′, and a top surface 11a3′ connecting the outer and inner surfaces. The housing 11′ defines a through hole 15′ extending from the outer surface 11a1′ to the inner surface 11a2′. The through hole 15′ is located in the connecting member 11a′ and is restricted by two pairs of sidewalls 151′.

While the voice coil is used in a transducer having a diaphragm, the connecting member of the voice coil is connected to the diaphragm, and the through hole is located between the diaphragm and the wire. When the diaphragm vibrates, the air below the diaphragm will be compressed and then leaks outside via the through hole, which balances the air pressures between the air below the diaphragm and the air out of the diaphragm.

While the present invention has been described with reference to a specific embodiment, the description of the invention is illustrative and is not to be construed as limiting the invention. Various of modifications to the present invention can be made to the preferred embodiment by those skilled in the art without departing from the true spirit and scope of the invention as defined by the appended claims.

What is claimed is:

1. A voice coil comprising:
a housing defining a connecting member and a combining member connected to the connecting member;
a wire wrapping around the combining member of the housing;
wherein the connecting member defines an outer surface, an inner surface opposed to the outer surface, a top surface connecting the outer and inner surfaces, and a through hole extending from the outer surface to the inner surface.

2. The voice coil as described in claim 1, wherein the through hole is a gap extending from the top surface toward the combining member.

3. The voice coil as described in claim 1, wherein the through hole is restricted by two pairs of sidewalls.

4. A transducer including a diaphragm and a voice coil connected to the diaphragm, the voice coil comprising:
a housing defining a connecting member and a combining member connected to the connecting member;
a wire wrapping around the combining member of the housing;
wherein the connecting member defines an outer surface, an inner surface opposed to the outer surface, a top surface connecting the outer and inner surfaces, and a through hole extending from the outer surface to the inner surface.

5. The transducer as described in claim 4, wherein the through hole is a gap extending from the top surface toward the combining member.

6. The transducer as described in claim 4, wherein the through hole is restricted by two pairs of sidewalls.
